(19) United States
(12) Patent Application Publication
(10) Pub. No.: US 2012/0208165 A1
(43) Pub. Date: Aug. 16, 2012

(54) Indicator of Satisfaction

(75) Inventors: Ville Levaniemi, Tampere (FI); Heikki Väänänen, Tampere (FI)

(73) Assignee: HAPPYORNOT OY, Tampere (FI)

(21) Appl. No.: 13/502,668

(22) PCT Filed: Oct. 21, 2010
(86) PCT No.: PCT/FI10/50828

§ 371 Date: Apr. 18, 2012

(30) Foreign Application Priority Data
Oct. 22, 2009 (FI) 20096093

(51) Int. Cl. G09B 3/00

(52) U.S. Cl. 434/350

(57) ABSTRACT

The invention relates to a method for measuring personal satisfaction by means of a device for giving feedback, which comprises an internal power source and at least two selector switches for giving feedback, indicating the type of the feedback, a memory for storing feedback data, and a data transmission module for transmitting the feedback data. The method comprises: presenting the subject for the feedback, receiving feedback from at least one person giving feedback, on the basis of the selection of a selector switch, storing the data on the feedback in the memory of the device for giving feedback, and transmitting the feedback data at a predetermined time from the device for giving feedback to a server in a wireless manner. The invention also relates to a device for giving feedback and a data processing system to be used in the method.

### FIELD OF THE INVENTION

The present invention relates to a device and a method for determining personal satisfaction. The invention also relates to a data processing system for processing personal satisfaction data.

### BACKGROUND OF THE INVENTION

Real-time personal satisfaction data reflecting the fulfilment of a person's expectations, whether relating to customer satisfaction or employee satisfaction, is very important for firms and other actors. A low degree of employee satisfaction causes problems in production, decreases creativity, increases employee turnover and may in the service sector lead to poor customer service, degrading customer satisfaction. A low degree of customer satisfaction, in turn, decreases a firm's cash flow, increases the amount of data shared on poor experiences, and affects the loyalty of customers as customers of the firm, and since securing a new customer will require even five-fold resources compared with maintaining existing customers, it is expensive for the firm to lose customers. A happy customer is more inclined to recommend a product or service he/she has bought and is more likely to buy the same product or service again. For these reasons, it would be important for firms to obtain information about the degree of personal satisfaction and changes in it, to be able to raise it by developing measures. Also, the measurements should be taken in real time, because when asking afterwards, damage has usually already been caused or the subject or the situation for feedback cannot be recalled so well any longer; consequently, it does not suffice to monitor the degree of satisfaction, for example, once or twice a year.

Personal satisfaction data can be collected by using, for example, feedback forms, boxes, stands, web sites, or by polling. In the above-presented solutions, the sampling fraction remains very small in practice because people are not often activated to give feedback by the above-presented methods. There may be several reasons for this, such as the time taken in filling out a form, hurry, and/or apprehension about the traceability of the person giving feedback. Furthermore, particularly polling involves high costs for a firm when carried out in the required extent.

A computer-assisted method is disclosed in patent application publication US 2003085927 A1. The evaluation component of the method comprises three icons: happy, neutral and not happy, whose selection together with possible written feedback is entered as the user's evaluation in the system. However, it is not possible to place computers anywhere, if only because of their size. Furthermore, because of their high power consumption, computers require a connection to an electrical network and also a connection to a data network, and a wireless connection is not available everywhere. Moreover, computers are not capable of operating long times on a stand-alone basis but they require an operator. Also, the vulnerability of computers (PC) to break down is a factor that significantly restricts their diverse use as devices for giving feedback. Particular disadvantages include vandalism, sensitivity to moisture and temperature variations, as well as risks of disorders in the complex system of software technology. Also, PC polls unavoidably involve a software environment/an operating system, involving risks of system disorders because of its complex operation. The above-presented problems also relate to devices comprising a touch screen.

Distinct devices for measuring personal satisfaction have also been developed. Patent publication U.S. Pat. No. 5,038,367 A discloses a device for giving feedback, to be placed, for example, in a bank lobby. A question printed on a frame and two response alternatives, yes or no, are posed to a customer. The responses are transferred via a cable to a computing unit, in which the polling result is updated in real time. A disadvantage of this device is at least the wiredness of the device; that is, the data transmission takes place via a data network cable. The use of the cable restricts the placement and moving of the device, because, for example, a wall socket will be needed for connecting the cable. For this reason, there are also initial costs related to the device.

### BRIEF SUMMARY OF THE INVENTION

It is an aim of the present invention to provide a solution to the drawbacks of the above-mentioned methods and systems for evaluating personal satisfaction or opinion and to present a novel, real-time and continuous method and system for indicating personal satisfaction, which provide firms and other actors with a cost-effective method for measuring personal satisfaction. The invention also relates to a device for giving feedback as part of the indicator of satisfaction and a data processing system according to the invention. The invention is characterized in what will be presented in the independent claims, and the dependent claims relate to advantageous embodiments of the invention.

The invention is based on the fact that a stand-alone indicator of satisfaction, measuring feedback in real time, is formed of at least one device for giving feedback, having an internal power source, and a server, for example a computer. The device for giving feedback comprises a user interface with 2 to 5 selector switches for giving feedback, which can be selected by persons giving feedback on a subject for feedback, a memory, in which the device for giving feedback stores the feedback data, and a data transmission module for wireless communication by the device for giving feedback. The device for giving feedback collects data on all the feedback received by a predetermined time, that is, the time of transmission, in its memory and transmits the data to a server in a wireless manner, for example in the form of a text message. The server parses the data and produces from the data a feedback report and transmits the report to the subscriber, for example, by email, or provides it to be readable via a www user interface. Furthermore, the device for giving feedback comprises the possibility of remote login; that is, the device can be monitored and controlled by communication between the server and the device without going to the device. In other words, the device for giving feedback can receive control messages, such as configuration or confirmation messages, from e.g. a service provider or a server, by means of its data transmission module.

In other words, a system for indicating satisfaction has been developed, in which a device for giving feedback, measuring feedback in real time, can, thanks to its structure and lack of an electric cable and wirelessness, be placed in a movable manner in the respective location for collecting feedback, where the device for giving feedback measures the feedback given by persons according to the selections made with the selector switches, and transmits the data on the feedback received, that is, the feedback data, at a predetermined transmission time wirelessly to a server that produces a report on the measurement data and transmits it to the subscriber.

According to an advantageous embodiment, the device for giving feedback comprises built-in means for presenting the subject of the feedback, for example a question signboard with a paper showing said subject, or a display which may also be arranged to change the question on the display to match with a new question included in a configuration message received by the device for giving feedback. It is also feasible that the device for giving feedback is equipped with a transmitter comprising a speaker, its memory being provided with a recording on the subject of the feedback, the recording being transmitted by the transmitter via its speaker at small intervals to the environment. An advantage of replaying the recording is to give an impulse that may arouse the interest to give feedback when passing by the device, even if the passer-by would not otherwise have found his/her way to the device.

According to another advantageous embodiment, the device for giving feedback does not comprise means for presenting the subject for giving feedback, but the subject is presented, for example in an auditory manner, for example by a public announcement in a store, or by email for example at a workplace, and the announcement or email tells about the feedback survey and presents the subject of the survey.

The selector switches for giving feedback can be advantageously, for example, buttons or push buttons, whose denotation can be advantageously indicated in a desired way that is suitable for each operating environment, for example by colours, a smiley symbol, − and + symbols, icons such as rose and hash patterns, hand signs or in any way that clearly indicates wheat type of feedback is given. It is also possible that the selector switches indicate objects of voting, such as images of faces of candidates, when the device for giving feedback acts as a voting device.

In an advantageous embodiment, the internal power source of the device for giving feedback consists of batteries or, for example, an accumulator. The use of an internal power source is supported by the property of the feedback device, according to which the device for giving feedback activates its data transmission module at the times of transmission or reception only and is in a power saving mode at other times. Thus, in normal use, the interval of replacing even conventional batteries in the device for giving feedback may be as long as 1 to 2 years. This feature supports the stand-alone function of the device. However, it is also possible to use an external power source, such as mains current. Nevertheless, when using the mains current, the electric cable of the device will limit, among other things, the placement of the device, because a wall socket should be available on site; furthermore, the electric cable may cause, for example, a risk of stumbling.

Advantageously, the wireless data transmission method used in the device for giving feedback is, for example, the common European GSM (Global System for Mobile communications) standard which enables the transmission of data and speech via a mobile telephone network. Thus, the data transmission module of the device for giving feedback is a GSM module and the data is transmitted in the form of text messages via the SMS (Short Message Service); in other words, the data is transmitted by utilizing a mobile telephone network. For example for cost reasons, the device for giving feedback can be arranged to include the feedback data to be transmitted to a server in the 160 characters of a text message, for example by packing the feedback data or by processing the feedback data in a character set format so that the feedback data can be transmitted in a single text message. The communication can also be arranged with multimedia messages or also totally by means of a GPRS (General Packet Radio Service) connection or by using a wireless communication network. The wirelessness, too, enhances the stand-alone function of the device for giving feedback.

According to an advantageous embodiment, the device for giving feedback is set to transmit the feedback data, that is, a result message, at a predetermined time of transmission. The time of transmission can be defined as a given moment of time, for example a time once a day, or the moment when a predetermined number of items of feedback data has been collected; for example, after a thousand feedback entries, the device will automatically transmit the feedback data to a server. The feedback data comprises information about each selection of a selector switch, received by the device for giving feedback after the previous transmission of feedback data, and a time stamp, that is, the time of selecting the selector switch.

According to another advantageous embodiment, the server is set to send an email report on the measurement data obtained from the device for giving feedback to a subscriber at predetermined intervals, for example once a week, or to provide the report to be read and studied by the subscriber via a web user interface.

Furthermore, according to an advantageous embodiment, the settings of the device for giving feedback can be adjusted by remote control via the user interface of the software in the server, for example a web user interface, or by means of a mobile phone by sending a text message to the device for giving feedback.

Furthermore, in an embodiment, the software of the server can be set to monitor deviations in the device for giving feedback on the basis of the content and/or the time of transmission of the result messages containing feedback data. The software can be set to monitor if the device for giving feedback functions within the limits of reference values set for it. The monitoring is carried out by processing the contents of the result messages. Operation deviating from the reference values includes, for example, cases in which the result message indicates that a selector switch has not been selected at all and/or no selections have been received for a suspiciously long interval of time, and/or the device does not transmit feedback data at a predetermined time of transmission. After detecting deviations from the reference values, the server can be set to automatically transmit a control message correcting the situation to the device for giving feedback, or the server can be set to transmit an alarm to the service provider, for example by email, a text message or by providing information on the deviating operation of the device for giving feedback to be readable via a web user interface. In this way, the service provider has the possibility of transmitting, either in a text message or via the web user interface of the server, a control message to the device for giving feedback, on the basis of which message the device for giving feedback will configure its settings. However, it is also possible to provide the device for giving feedback with a processor for processing the entered feedback before the feedback data is transmitted to the server. The processor of the device for giving feedback detects, for example, that a button has not been pressed at all for three hours, which time had been set as a reference value for the processor, during which time all the buttons of the device for giving feedback should be pressed at least once. After finding the deviation, the device for giving feedback transmits an alarm message to the server which, in turn, operates in the same way as in the case in which a deviation in the feedback data was found by the software of the server itself. Using the processor of the device for giving feedback, the service provider will be informed sooner on the deviating operation of the device for giving feedback.

The invention provides significant advantages to prior art. The embodiment according to the invention, which does not comprise a display and is optimized in its other configurations of power consumption as well, will enhance the battery-operatedness of the device for giving feedback. Thus, an electric cable will be rendered unnecessary, and the device can still stand alone without maintenance for longer than a year or even two. Yet another advantage is the fact that the software of the server monitors the operation of the device for giving feedback and either corrects the problems by automatically transmitting a configuration message to the device for giving feedback or by giving an alarm to the service provider who can adjust the device by remote control without going to the device. In addition to problems in the device for giving feedback, manipulation of the device for giving feedback may be detected during the monitoring by the server, because too frequent selections or “thrumming” of selector switches may be detected in the time stamps of the feedback data, in which case a control message can be sent to the device for giving feedback, either by the server or by the service provider alarmed by the server, in which message a minimum interval is set between the selections of the selector switches, and more frequent selections will not be registered by the device for giving feedback. Manipulation can also be detected on the basis of other reference values. As the reference values, it is also possible to set, for example, a time span when the entering of feedback is acceptable, that is, for example, the opening hours of the site of feedback. However, if it is detected from the time stamps of the feedback data of the result message by the server that the feedback has been given outside the time span defined by the reference values, that is, at a wrong time, the server will give an alarm.

Another noteworthy advantage is the small number of selector switches in the device, 2 to 5 selector switches, and the clear marking of the selector switches to indicate the type of the desired feedback. These features contribute to the simplicity of the device and the ease of giving feedback. A device that is easy to use and is placed correctly, that is, exactly at the site of feedback, will make the person give feedback more easily without feeling that the giving of feedback is hard or time consuming. Thus, the person giving the feedback may also give feedback even if having nothing special to comment on, that is, just by his/her intuition, wherein the number of feedback entries received will be greater and the result will be more extensive. In one advantageous embodiment, the device for giving feedback comprises only 2 selector switches: yes and no. The advantages of the small number of selector switches have been listed above. In this embodiment, a selector switch indicating neutrality is not used, because it could receive disproportionate popularity, due to the easy solution offered by it.

Furthermore, a sight guard possibly placed in the vicinity of the selector switches prevents the visibility of the selection of the selected switch, that is, the type of the feedback given, to outsiders, thereby indicating the privacy of the giving of feedback and also lowering the threshold to give feedback.

In addition to the advantages mentioned above, another advantage to be taken into account is the fact that the device for giving feedback can be made compact, without an electric cable, and wireless. These characteristics make the device stand alone and advantageous but also light-weight, movable and easy to place. The mobility enables the versatile use of the device for giving feedback and makes it possible to carry out the surveys where the experiences for the feedback are obtained. Thanks to this, the feedback is more correct, because the feedback is obtained at once at the site of the experience, after the service or other experience.

Further advantages may include the ease of use of the terminal and its easy introduction into use, which is influenced, among other things, by the fact that the settings of the device can be adjusted by remote control, for example by text messages, and the person taking it into use, that is, the subscriber of the service, does not need to buy installation services nor to learn how to adjust the device. Also in fault situations, the problem can be solved by remote control.

### BRIEF DESCRIPTION OF THE DRAWINGS

The invention will now be described in more detail in connection with preferred embodiments with reference to the appended drawings, in which:

FIG. 1 shows the user interface of a device for giving feedback according to an embodiment, seen from above,

FIG. 2 shows a device for giving feedback according to an embodiment, in a block chart;

FIG. 3 shows the operation of a system for indicating satisfaction according to an embodiment, in a schematic chart;

FIG. 4 shows the configuration route of the device for giving feedback according to an embodiment, in a schematic chart; and

FIG. 5 shows the device for giving feedback according to FIG. 1, placed in its environment of use.

### DETAILED DESCRIPTION OF THE INVENTION

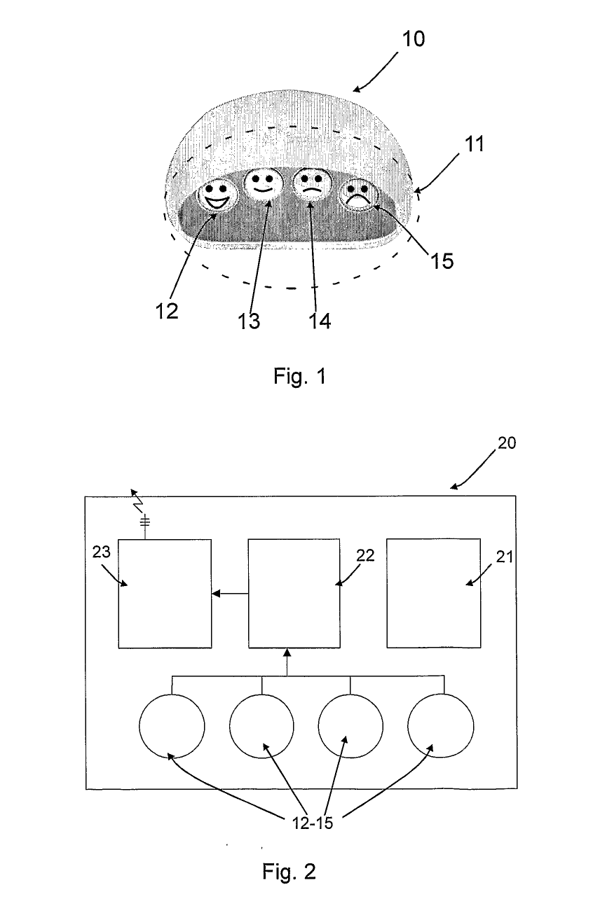

FIG. 1 shows the user interface 11 of a device for giving feedback 10, seen from above. The user interface 11 according to this embodiment comprises four buttons 12 to 15 used as selector switches for giving feedback, each indicating the quality of feedback desired. The first button 12 from the left indicates great satisfaction, the second button 13 moderate satisfaction, the next button 14 moderate dissatisfaction, and the last button 15 from the left, or the first one from the right, indicates great dissatisfaction. In connection with the buttons 12 to 15, it is also possible to connect an acknowledgement function to indicate, after pressing of a button, that the pressing of the button was entered, for example by an acoustic signal, such as a clicking sound or a flash of light, such as the flashing of a LED light placed in or around the button.

Mechanically implemented selector switches for giving feedback are user friendly, because they are firm in structure and explicit, and they do not involve the same problems as, for example, touch screens which may raise questions on how one should act. Moreover, devices comprising a touch screen may also, for example, shift into a power saving mode, or the software of the device may tilt.

The selector switches 12 to 15 can also be replaced by other means, according to the need: for example, by stepping onto a light pattern, by cutting a beam of light, by audio commands, etc.

FIG. 2 shows a device for giving feedback 20 according to an embodiment, in a block chart. The device for giving feedback 20 comprises an internal power source 21, a memory 22, a wireless data transmission module 23, and buttons 12 to 15 used as selector switches for giving feedback. In this embodiment, the power source 21 consists of batteries. The memory 22 is arranged to receive and to store the feedback data, that is, the selections of the buttons 12 to 15 and the time stamps of the selections. The buttons 12 to 15 are electronically connected to the memory. Furthermore, the device for giving feedback 20 is arranged to transfer the selection data at a selected time from the memory 22 to the data transmission module 23 which is arranged to transmit the feedback data wirelessly to a text message gateway.

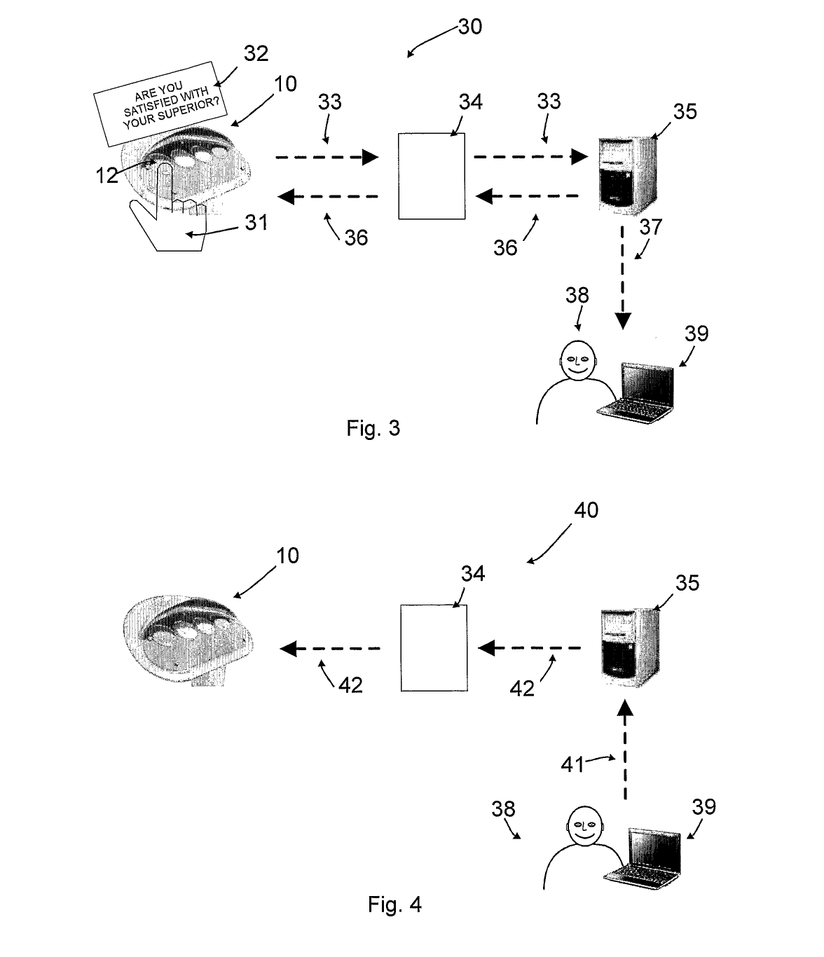

FIG. 3 is a schematic chart showing the operation of a system for indicating satisfaction 30, measuring personal satisfaction data, according to an embodiment. As shown in FIG. 3, a person 31 giving feedback notices a question on a question signboard 32 attached to the device for giving feedback 10 and gives the desired feedback by pressing a button 12 in the device for giving feedback 10. In the device for giving feedback 10, the received feedback data that comprises information on the selected button and a time stamp comprising information on the moments of time of the selections, that is, the times when feedback was given, is stored in the memory. After this, the device for giving feedback 10 will remain waiting for the next pressing of a button. Until a predetermined moment of transmission, the device for giving feedback 10 collects information about the feedback given in its memory, to be included in a result message 33 which comprises the feedback data and is transmitted in the form of a text message at the time of transmission by the device 10, by means of its data transmission module, such as a GSM module, to a text message gateway 34 and further to a server 35. The server 35 is in a functional connection with a text message gateway 34, via which the message is transmitted to the server 35, for example over a cabled or wireless communication network.

The time of transmission of the result message 33 from the device for giving feedback 10 can be defined to be suitable for the need in each case. The result messages 33 can be delivered at given times, for example at intervals of an hour or once a day or after collecting a desired and predetermined number of feedback entries for the device for giving feedback, for example ten, hundred or thousand feedback entries.

In response to the result message 33 received, the server 35 transmits an acknowledgement message, that is, a confirmation message 36, also via the text message gateway 34, which confirmation message is received by the device for giving feedback 10, by means of its data transmission module. The confirmation message 36 comprises information about the successful receipt of the result message 33 and prevents unnecessary retransmission of the result message 33. The server 35 will automatically parse the received feedback data to a parsed report 37 which the server 35 will transmit at a predetermined time to the subscriber 38 of the service. From the report 37 produced on the basis of the feedback data, the subscriber 38 of the service will obtain information about the button selections and the time stamps, that is, the times of the selections, at a defined accuracy.

In addition to the selection of the button, the time stamp is an important item of information because it can be used by the subscriber 38 of the service to find out how many times each button has been pressed, for example, during the work shifts of different workers. This information can be used, for example, in a store to monitor customer service performance during different shifts to find out if the feedback is consistent during the whole day. In addition to the report 37, all the feedback data can also be presented in a web user interface 39, where the feedback data can be monitored for example daily, even if the report 37 had been set to be transmitted, for example, once a week.

The number of devices for giving feedback 10 in the systems 30 for indicating satisfaction is not limited in any way. In the case of a system 30 for indicating satisfaction, comprising several devices for giving feedback 10, the feedback data from the devices for giving feedback 10 can be transmitted to a common server 35 which piles up the feedback data, automatically draws up the report 37 and further transmits the report 37 to the subscriber 38 of the service.

FIG. 4 shows, in a schematic chart, the steps of configuring a satisfaction indicator 40 according to one embodiment, measuring personal satisfaction data and comprising a device for giving feedback 10. The service provider 38 decides to change the settings of the device for giving feedback 10 of the satisfaction indicator 40, and makes the changes by means of the web user interface 39. The changes are transmitted in a web configuration message 41 to the software of the server 35 which arranges the configuration data to be updated into the form of a configuration message 42 to be transmitted to the device for giving feedback 10. The configuration message 42 is transmitted via a text message gateway 34 to the device for giving feedback 10. The message 42 contains instructions for the device for giving feedback 10 to change its settings to comply with the settings by the service subscriber 38 in the web user interface. The device for giving feedback 10 changes its settings after receiving the configuration message 42.

The purpose of configuration messages to be transmitted to the device for giving feedback is to make it possible to adjust the device to be optimal for application in each site of use. The delay in accepting selections of the selector switches, that is the entry interval, which can be adjusted by the configuration messages, needs to be adjusted to be different, for example, in cases of an employee survey and a customer satisfaction survey. In an employee survey, the employees of a work shift may exit through a door, for example, in a queue, wherein a short delay is needed for an entry, whereas in a customer satisfaction survey, a longer delay will be needed to minimize an error caused, for example, by “thrumming” by children. In addition to the delay of acceptance, it is also possible to adjust, for example, the time of transmission of the feedback data, that is, to change the time when the feedback data is transmitted, or to make the number of items of feedback to be received larger or smaller before the transmission of the feedback data. By means of the configuration messages, it is thus possible to adjust the characteristics of the device as desired, at desired times, without a physical contact to the device.

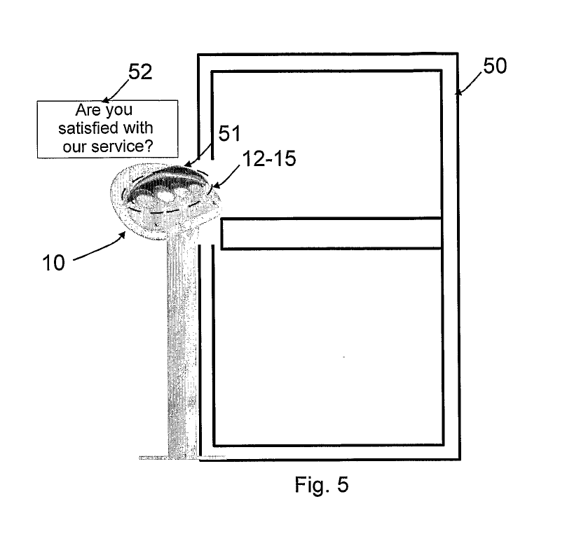

FIG. 5 shows a possible location for the device for giving feedback 10 of the satisfaction indicator shown in FIG. 1. The device for giving feedback 10 is placed in the close vicinity of a door 50, which is possible, because the device for giving feedback 10 is completely wireless and cordless, quick in giving the feedback; in other words, the persons giving feedback do not form a queue because the user interface 11 is sufficiently simple. Furthermore, the device for giving feedback 10 has a sight guard 51 in the vicinity of the buttons 12 to 15. The sight guard will conceal the pressing of the option buttons 12 to 15 from outsiders.

The device for giving feedback 10 is wireless, because the data transmission to the server is implemented in a wireless manner and batteries are used as the power source. The battery-operatedness is enhanced by the optimized power consumption of the device for giving feedback 10, which is arranged, among other things, in such a way that not only is there no display but the device 10 is also, for a large part of the time, in a power saving mode. In other words, for example, the GSM module is active only when data is being transmitted either from the server 35 to the device 10 or from the device 10 to the server 35.

Information about the subject of the feedback is arranged in the form of a question signboard 52 in connection with the device for giving feedback 10 in such a way that it will be clear to the persons giving feedback, what the feedback is asked on. The content of the question signboard 52 can be changed very quickly to be suitable for the measurement each time, for example, by printing out a new question on paper and attaching it, for example, on a wall behind the device for giving feedback 10, or in the device for giving feedback 10 itself. The question signboard 52 may also be an electronic display or an electronic paper in connection with the device for giving feedback, wherein the question can be changed by sending a configuration message 42 from the server 35 to the device for giving feedback 10. However, the information about the subject of the feedback can also be presented in another way, for example by a public announcement in a store or by email at a workplace. In this case, the announcement or the email will tell about the feedback survey and present the subject of the survey.

The device for giving feedback can be placed almost anywhere at the respective site of feedback, that is, for example, at the door of a grocery store or in the vicinity of a perishable goods counter, in a barber-shop, at the front door of an office, at a gym, in the social premises of a factory, or in any place where personal feedback is wanted. Furthermore, depending on the location, the devices for giving feedback may be very different in size or appearance, table versions or versions to be attached onto a wall or on a railing, but still wireless and cordless, requiring only putting in place at the site and turning on the device, because the adjustments, the data and the other information required are transmitted in a wireless manner from a remote control location, a server or a mobile phone to the device for giving feedback.

Furthermore, with the choice of selector switches in the device for giving feedback, it is possible to facilitate the giving of feedback by, for example, blind persons, by using selectors indicated with braille, or the giving of feedback by persons with other handicaps by using large selectors.

In employee satisfaction surveys, it is also possible to take into account the opinions of persons with mobile jobs by using an automatic text message survey, wherein persons with mobile jobs receive a text message transmitted by the software of the server, to which they reply by a text message, and whose results may be added to the feedback data measured by means of the device for giving feedback at the workplace and included in the overall report.

Although, in the above-presented embodiments, the data received by and transmitted from the device for giving feedback is transmitted primarily in the form of text messages, it should also be taken into account that the data can advantageously be transmitted by other connections as well. Thus, data can be transmitted by setting up any wireless packet connection, such as Internet, GPRS data or all-IP 3G, between the device for giving feedback and the server.

However, the invention and its embodiments are not limited to those presented above, but the basic idea of the invention can be implemented in a variety of ways. Thus, the invention and its embodiments are not limited to the above-described examples but they may vary within the scope of the claims.

1. A method for measuring personal satisfaction by means of a device for giving feedback, the device for giving feedback comprising an internal power source and at least two selector switches for giving feedback, which are marked to indicate the type of the feedback, a memory for storing the feedback data, and a data transmission module for transmitting the feedback data, the method comprising:
defining a time based on received information for the device for giving feedback to transmit the feedback data which is stored in the memory;
presenting the subject for feedback;
receiving feedback from at least one person giving feedback, on the basis of the selection of a selector switch;
storing the data on the feedback in the memory of the device for giving feedback;
transmitting the feedback data stored in the memory at said defined time from the device for giving feedback to a server by means of the data transmission module in a wireless manner.

2. The method according to claim 1, wherein the method further comprises receiving control data from the server by means of the data transmission module in a wireless manner.

3. The method according to claim 1, wherein the data transmission module is active only when transmitting the feedback data or receiving control data.

4. The method according to claim 1, wherein the feedback data is transmitted in the form of a text message and the feedback data comprises information about the numbers of selections of each selector switch, as well as the time stamps of the selections.

5. The method according to claim 1, wherein a report on the feedback data transmitted by the device for giving feedback is formed in the server and the server is transmitted to the subscriber of the feedback.

6. The method according to claim 1, wherein a report on the feedback data transmitted by the device for giving feedback is formed in a server and the report is provided to be readable via a web user interface.

7. A device for giving feedback, for collecting feedback, the device for giving feedback comprising an internal power source, at least two selector switches for giving feedback, marked to indicate the type of feedback, a memory for storing the feedback data, and a data transmission module, wherein a time for transmitting the feedback data stored in the memory is defined on a basis of received information for the device for giving feedback and wherein the data transmission module is arranged to transmit the feedback data stored in the memory in a wireless manner at said defined time from the device for giving feedback to a server.

8. The device for giving feedback according to claim 7, the device for giving feedback being arranged to receive control data which comprises configuration data for the device for giving feedback, or an acknowledgement of receipt of feedback data.

9. The device for giving feedback according to claim 7, the device for giving feedback being arranged to transmit the feedback data and to receive control data in the form of a text message.

10. The device for giving feedback according to claim 7, wherein the data transmission module is arranged to be active only when transmitting the feedback data or receiving control data.

11. The device for giving feedback according to claim 7, wherein the feedback data comprises information about the numbers of selections of each selector switch as well as the time stamps of the selections.

12. A data processing system for processing personal satisfaction data, the data processing system comprising:
means for presenting a question for feedback;
at least one wireless device for giving feedback, the device for giving feedback comprising at least two selector switches for giving feedback, marked to indicate the quality of feedback, a memory for storing the feedback data, and a data transmission module, wherein a time for transmitting the feedback data stored in the memory is defined on a basis of received information for the device for giving feedback and wherein the data transmission module is arranged to transmit the feedback data stored in the memory in a wireless manner at said defined time from the device for giving feedback to a server, as well as to receive control data; and
a server comprising a data transmission module arranged to receive feedback data from at least one device for giving feedback as well as to transmit control data to at least one device for giving feedback data, and software arranged to monitor the feedback data and to produce a report on the basis of the feedback data.

13. The data processing system according to claim 12, wherein the data transmission module is active only when transmitting the feedback data or receiving control data.

14. The data processing system according to claim 12, wherein the device for giving feedback is arranged to transmit the feedback data and to receive control data in the form of a text message.

15. The data processing system according to claim 12, wherein the server is arranged to process the feedback data to detect deviations in the feedback data compared with reference values set for the feedback data.

16. The data processing system according to claim 15, wherein the server is arranged to give an alarm to the service provider and/or to transmit control data to the device for giving feedback, to correct a deviation by means of its data transmission module, if the server detects at least one deviation in the feedback data compared with reference values set for the feedback data.
